(19) United States
(12) Patent Application Publication
(10) Pub. No.: US 2007/0252310 A1
(43) Pub. Date: Nov. 1, 2007

(54) Method for manufacturing a plugged honeycomb filter with a single firing cycle

(76) Inventors: David John Brockway, Bellefonte, PA (US); Srinivasan Karthik Govindajaran, Painted Post, NY (US); Jonathan Michael Mis, Horseheads, NY (US); Rebecca Lynn Schulz, Horseheads, NY (US); Gary Graham Squier, Beaver Dams, NY (US); Kathleen Ann Wexell, Corning, NY (US)

Correspondence Address: CORNING INCORPORATED, SP-TI-3-1, CORNING, NY, 14831, US

(21) Appl. No.: 11/414,282

(22) Filed: Apr. 27, 2006

(51) Int. Cl. H05B 6/64; C04B 33/32

(52) U.S. Cl. 264/432; 264/630

(57) ABSTRACT

A method for manufacturing a honeycomb structure comprising providing a green honeycomb structure having a plurality of cell channels extending therethrough, inserting a plug material into at least a subset of the cell channels of the green honeycomb structure to form a plurality of plugs therein, and drying the plugs by exposing the plugs to electromagnetic energy, such as microwave energy.

### BACKGROUND OF THE INVENTION

This invention relates to charging flowable materials into selected cells of a honeycomb structure and drying the flowable materials and honeycomb structure, and more particularly, to a method for drying the flowable materials and a green honeycomb structure.

Honeycomb structures having traverse cross-sectional cellular densities of approximately one tenth to one hundred cells or more per square centimeter have several uses, including solid particulate filter bodies and stationary heat exchangers. Such uses require selected cells of the structure to be sealed or plugged by manifolding and the like at one or both of the respective ends thereof. The term “sealed” and other corresponding grammatical forms, i.e., sealant, sealing, etc., are used herein to refer to both porous and non-porous methods of closing the open transverse cross-sectional areas of cells.

The reference numeral 10 (FIG. 1) generally designates a solid particulate filter body that is generally well known and that may be fabricated utilizing a honeycomb structure 12 formed by a matrix of intersecting, thin, porous walls 14 surrounded by an outer wall 15, which in the illustrated example is provided a circular cross-sectional configuration. The walls 14 extend across and between a first end face 18 and an opposing second end face 20, and form a large number of adjoining hollow passages or cell channels 22 which also extend between and are open at the end faces 18, 20 of the filter body 10. To form the filter 10 (FIGS. 2 and 3), one end of each of the cells 22 is sealed, a first subset 24 of the cells 22 being sealed at the first end face 20, and a second subset 26 of the cells 22 being sealed at the second end face 18 of the filter 10. Either of the end faces 18, 20 may be used as the inlet face of the resulting filter 10.

In operation, contaminated fluid is brought under pressure to an inlet face and enters the filter 10 via those cells which have an open end at the inlet face. Because these cells are sealed at the opposite end face, i.e., the outlet face of the body, the contaminated fluid is forced through the thin porous walls 14 into adjoining cells which are sealed at the inlet face and open at the outlet face. The solid particulate contaminant in the fluid, which is too large to pass through the porous openings in the walls, is left behind and a cleansed fluid exits the filter 10 through the outlet cells and is ready for use.

For the mass production of such filters and heat exchangers, it is highly desirable to be able to seal selected cell channels ends as rapidly and as inexpensively as possible. Sealing these selected cells comprises inserting a plugging material into the open ends of selected cell channels and subsequently drying the plugged filter. Previous methods for drying have included firing a high porosity ware, such as a green honeycomb structure, within a drying oven, plugging the open ends of selected cell channels, and re-firing the plugged honeycomb structure. These previous techniques have resulted in cracks and stress fractures within the walls of the channels, and filter bodies with a decreased structural integrity. Moreover, these previous techniques are relatively expensive as well as time intensive.

A method for plugging and drying extruded honeycomb structures, such as ceramic particulate traps for diesel engines, is desired that is highly repeatable and accurate, while simultaneously having a short cycle time and resulting in a filter with a relatively greater structural integrity.

### SUMMARY OF THE INVENTION

One aspect of the present invention is to provide a method for manufacturing a honeycomb structure, the method comprising providing a green honeycomb structure having a plurality of cell channels extending therethrough, inserting a plug material into at least a subset of the cell channels of the green honeycomb structure to form a plurality of plugs therein, and drying the plugs by exposing the plugs to electromagnetic energy. Preferably, the step of drying the plugs includes exposing the plugs to microwave energy. Preferably, the green honeycomb structure is manufactured from a cordierite forming precursor material.

The present inventive method is highly accurate and repeatable, may be completed in a relatively short cycle time, is relatively easy to perform, and results in a filter with a relatively greater structural integrity. The method further reduces the relative cracking and stress fractures within the desired structure produced during the drying process, reduces manufacturing costs as associated with the cycle times, is efficient to use, and is particularly well-adapted for the proposed use.

These and other advantages of the invention will be further understood and appreciated by those skilled in the art by reference to the following written specification, claims and appended drawings.

### BRIEF DESCRIPTION OF THE DRAWINGS

FIG. 1 is a perspective view of an extruded filter body including a first end having a plurality of open-ended cell channels.

FIG. 2 is a perspective view of the extruded filter body, wherein a first subset of the cell channels are plugged, and a second subset of the cell channels are open-ended

FIG. 3 is a side view of the filter body including a second end, wherein the first subset of the cell channels are open-ended and a second subset of the cell channels are plugged.

FIG. 4 is a flow chart of a process for forming a plugged honeycomb structure, and embodying the present invention.

FIG. 5A is a cross-sectional side view of a green honeycomb structure, a top platen and a bottom platen, with the top platen located in a starting position.

FIG. 5B is a cross-sectional side view of the green honeycomb structure and the top and bottom platens with a plugging material inserted into the second subset of the cell channels.

FIG. 6 is an enlarged cross-sectional side view of the area IV, FIG. 5B.

### DETAILED DESCRIPTION OF THE PREFERRED EMBODIMENTS

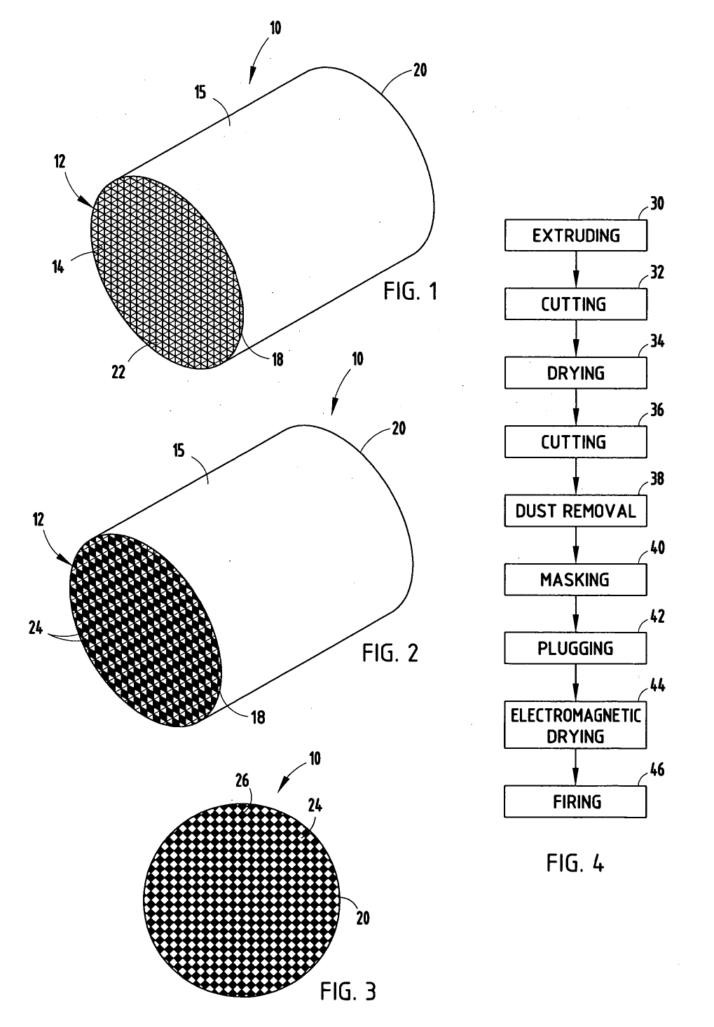

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

Several methods and procedures are known in the art for forming the honeycomb structure 12 of FIG. 1 that includes the plurality of hollow passages or cell channels 22 extending therethrough. The present inventive process is incorporated within an overall process that comprises extruding 30 (FIG. 4) a wet, preferably aqueous-based ceramic precursor mixture through an extrusion die to form a wet log, cutting 32 the wet log formed during the extrusion step into a plurality of segmented portions, and drying 34 the segmented portions so as to form a green honeycomb form (a green honeycomb log). The aqueous-based ceramic precursor mixture preferably comprises a batch mixture of cordierite forming inorganic precursor materials, an optional pore former such as graphite or starch, a binder, a lubricant, and a vehicle. The inorganic batch components can be any combination of inorganic components which can, upon firing, provide a porous ceramic having primary sintered phase composition comprised of cordierite.

In one aspect, the inorganic batch components can be selected from a magnesium oxide source; an alumina-forming source; and a silica source. The batch components are further selected so as to yield a ceramic article comprising predominantly cordierite, or a mixture of cordierite, mullite and/or spinel upon firing. For example, and without limitation, in one aspect, the inorganic batch components can be selected to provide a ceramic article which comprises at least about 90% by weight cordierite; or more preferably 93% by weight the cordierite. The cordierite-containing honeycomb article consists essentially of, as characterized in an oxide weight percent basis, from about 49 to about 53 percent by weight. SiO₂, from about 33 to about 38 percent by weight. Al₂O₃, and from about 12 to about 16 percent by weight MgO.

To this end, an exemplary inorganic cordierite precursor powder batch composition preferably comprises about 33 to about 41 weight percent of an aluminum oxide source, about 46 to about 53 weight percent of a silica source, and about 11 to about 17 weight percent of a magnesium oxide source. Exemplary non-limiting inorganic batch component mixtures suitable for forming cordierite are disclosed in U.S. Pat. Nos. 3,885,977; 5,258,150; US Pub. No. 2004/0261384 and 2004/0029707; and RE 38,888.

The inorganic ceramic batch components can be synthetically produced materials such as oxides, hydroxides, and the like. Alternatively, they can be naturally occurring minerals such as clays, talcs, or any combination thereof. Thus, it should be understood that the present invention is not limited to any particular types of powders or raw materials, as such can be selected depending on the properties desired in the final ceramic body.

The process further comprises cutting or segmenting 36 the green honeycomb form into green honeycomb structures of a desired length, and thereafter removing dust 38 from the green honeycomb structures as formed during the cutting step 36, i.e., the green ceramic precursor cutting dust. The dust is removed to improve the adherence of the plug material to the wall and to improve the adherence of the mask to the end of the structure. The dust removal step is preferably accomplished by passing high velocity air through the cell passages 22 of the structure after the cutting step to dislodge and remove any cutting dust. Each end face 18, 20 of each honeycomb structure 12 is then masked 40 with a suitable mask, and selected cell passages 22 are charged with a plugging material to form plugs 42 in selected ones of the cell channels to form a plugged, green honeycomb structure, as described below.

The plugged, green honeycomb structure is then dried 44 by exposing the plugged, green honeycomb structure to an electromagnetic energy, in accordance with the present invention. The dried, plugged, green honeycomb structure may then be fired 46 for further sintering and to form the fired ceramic article. Several steps of this overall process are known to those skilled in the art, and as such the steps of extruding 30, the primary cutting step 32, the step of drying 34, the secondary cutting step 36, and the masking step 40 are not discussed in detail herein.

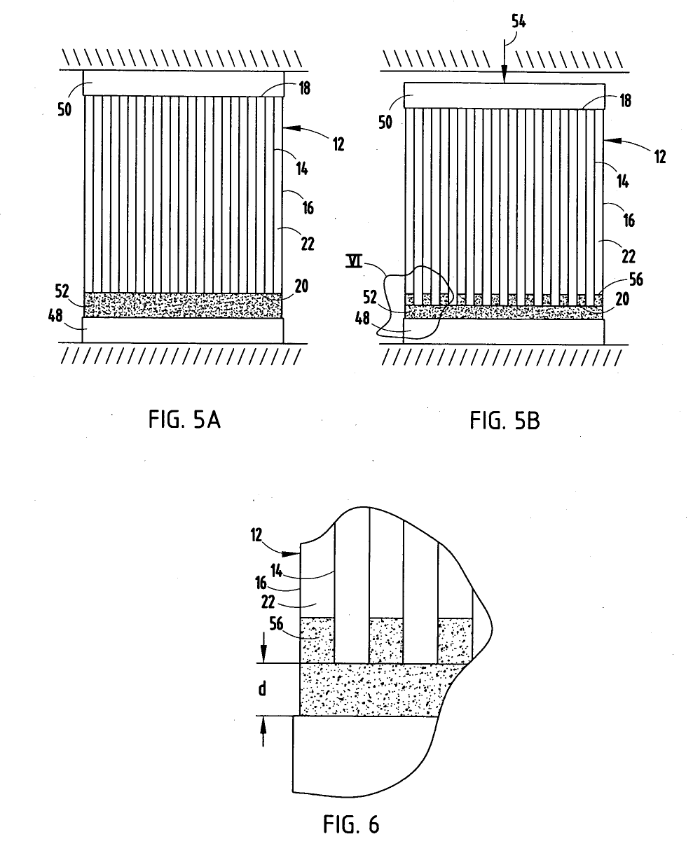

The step of plugging the green honeycomb structure 12 includes charging or otherwise introducing a flowable plugging cement material, such as a slurry preferably comprising a water diluted ceramic solution, into selected cell channels 22 as determined by the plugging mask. Formation of plugging masks may be by the method taught in U.S. Ser. No. 11/287,000 filed Nov. 20, 2005, for example, entitled “Apparatus, System and Method For Manufacturing A Plugging Mask For A Honeycomb Substrate” which is hereby incorporated by reference herein. An example of the plugging process 42 is best illustrated in FIGS. 5a and 5b, and utilizes a fixed bottom platen 48 and a movable top platen or piston 50. The present configuration of the platens 48, 50 are for illustrative purposes only, and it is noted that other methods for charging or plugging the cell channels 22 may be utilized, including utilizing a fixed top platen and a movable bottom platen, or moveable top and bottom platens. In the illustrated example, the plugging material is provided in the form of a cement patty 52 (having a shape of the end face 20 of the structure 12). The patty 52 is positioned between the bottom platen 48 and the second end face 20 of the green honeycomb structure 12. The top platen or piston 50 is then moved in a direction as indicated in FIG. 5B and represented by directional arrow 54 so as to force at least a portion of the plugging material or cement patty 52 into the unmasked open ends of the cell channels 22, thereby forming a plurality of plugs 56 within selected cell channels 22. In accordance with the present invention, the plugs 56 are provided so as to have a depth “d” of preferably between 0.5 mm to 20 mm, more preferably to have a depth “d” of between 0.5 mm and 12 mm, and most preferably to have a depth “d” of between 0.5 mm and 9 mm, so as to provide proper plugging of the cell channels 22 and proper drying of the plugs 56 during the electromagnetic drying step 44. After charging-insertion step of the cement 52 to form plugs 56 is complete, the mask is preferably removed from ends 18 and 20 of the structure 12. Although plugging by using a patty is described herein, the plugging step may be accomplished by any know plugging method, such as taught in U.S. Pat. No. 4,818,317; PCT/US05/042672 filed Nov. 5, 2005; U.S. Pat. No. 4,427,728; U.S. Pat. No. 4,557,682; U.S. Pat. No. 4,557,773; U.S. Pat. No. 4,715,801; and U.S. Pat. No. 5,021,204 for example. Suitable plugging materials may be of the same or similar composition as the green honeycomb structure, or optionally as described in U.S. Pat. No. 4,329,162 to Pitcher and U.S. Pat. No. 4,297,140 to Paisley.

The electromagnetic drying step 44 comprises drying the plugs 56 as formed within the cell channels 22 of the green honeycomb structure 12 by exposing the plugs 56 to electromagnetic energy. Preferably, this electromagnetic energy is provided in the form of microwave, however, other suitable forms of electromagnetic energy may also be utilized for the drying of the plugs 56. The microwave drying of the plugs 56 results in a relatively quick and uniform heating of the green honeycomb structure and the plugs 56, thereby reducing shrinkage of the plugs 56 and decreasing the heat stress exerted on the porous walls 14 of the green honeycomb structure 12 during the drying step 44 as compared to conventional drying means. This reduction in stress as exerted on the porous walls 14 results in a greater structural integrity of the resultant particulate filter. The plugs 56 are preferably exposed to the microwave energy until the water content of the plugs 56 are less than 50% of a 100% wet plug weight, more preferably less than 10% of the 100% wet plug weight, and most preferably less than about 5% of the 100% plug weight, with the 100% wet plug weight being defined as the water content of the plug 56 prior to being exposed to the microwave energy. Preferably, the microwave energy is provided within the range of from about 3 MHz to about 3 GHz, more preferably within the range of from about 27 MHz to about 2.45 GHz, and most preferably within the range of from about 915 MHz to about 2.45 GHz. Further, the electromagnetic drying step 44 includes exposing the plugged green honeycomb structure to a power lever per unit volume of preferably between 0.0001 kW/in³ and 1.0 kW/in³, and more preferably within the range of between 0.001 kW/in³ and about 1.0 kW/in³. Moreover, the energies as noted above are preferably applied to the plugged green honeycomb structure for a time of less than or equal to 60 minutes, and more preferably for a time of less than or equal to 5 minutes. Electromagnetic drying, such as microwave drying, is discussed in U.S. Pat. No. 6,706,233 and US 2004/0079469.

As noted above, the firing or sintering step 46 may be conducted subsequent to electromagnetically drying 44 the green honeycomb structure. This step is preferably conducted via conventional sintering means at a temperature of above 1300° C. and for a sufficient time so as to form a predominant phase of cordierite. It is also noted that the drying step is preferably conducted with the honeycomb structure in a horizontal orientation.

One aspect of the present invention is to provide a method for manufacturing a honeycomb structure, the method comprising providing a green honeycomb structure having a plurality of cell channels extending therethrough, inserting a plug material into at least a subset of the cell channels of the green honeycomb structure to form a plurality of plugs therein, and drying the plugs by exposing the plugs to electromagnetic energy.

It will become apparent to those skilled in the art that various modifications to the preferred embodiment of the invention as described herein can be made without departing from the spirit or scope of the invention as defined in the appended claims. Thus, it is intended that the present invention covers the modifications and variations of this invention provided they come within the scope of the appended claims and the equivalents thereto.

What is claimed is:

1. A method for manufacturing a plugged honeycomb structure, comprising:
providing a green honeycomb structure having a plurality of cell channels extending therethrough;
inserting a plug material into at least a subset of the cell channels of the green honeycomb structure to form a plurality of plugs therein; and
drying the plugs by exposing the plugs to electromagnetic energy.

2. The method of claim 1, wherein the inserting step includes providing the plug material as an aqueous-based material.

3. The method of claim 1, wherein the drying step includes exposing the plugs to the electromagnetic energy until a water content of the plugs is less than about 50% of a 100% wet plug weight.

4. The method of claim 3, wherein the drying step includes exposing the plugs to the electromagnetic energy until the water content of the plugs is less than about 10% of the 100% wet plug weight.

5. The method of claim 3, wherein the drying step includes exposing the plugs to the electromagnetic energy until the water content of the plugs is less than about 5% of the 100% wet plug weight.

6. The method of claim 1, wherein the inserting step includes providing the plug material with components which exhibit a dielectric constant of equal to or greater than 3 at 20° C., wherein susceptibility to the electromagnetic energy is improved.

7. The method of claim 1, wherein the step of drying the plugs includes exposing the plugs to microwave energy.

8. The method of claim 7, wherein the step of drying includes providing the microwave energy within the range of from about 3 MHz to about 3 GHz.

9. The method of claim 8, wherein the step of drying includes providing the microwave energy within the range of from about 27 MHz to about 2.45 GHz.

10. The method of claim 9, wherein the step of drying includes providing the microwave energy within the range of from about 915 MHz to about 2.45 GHz.

11. The method of claim 1, wherein the drying step includes exposing the plugs to the electromagnetic energy at a power level per unit volume of within the range of from about 0.0001 kW/in³ and to about 1.0 kW/in³.

12. The method of claim 11, wherein the drying step includes exposing the plugs to the electromagnetic energy at a power per unit volume of within the range of from about 0.001 kW/in³ to about 0.1 kW/in³.

13. The method of claim 1, wherein the drying step includes exposing the plugs to the electromagnetic energy for less than or equal to about 60 minutes.

14. The method of claim 13, wherein the drying step includes exposing the plugs to the electromagnetic energy for less than or equal to about 5 minutes.

15. The method of claim 1, wherein the inserting step includes inserting the plug material into the cell channels to a depth of from about 0.5 mm to about 20 mm.

16. The method of claim 15, wherein the inserting step includes inserting the plug material into the cell channels to a depth of less than or equal to about 12 mm.

17. The method of claim 16, wherein the inserting step includes inserting the plug material into the cell channels to a depth of less than or equal to about 9 mm.

18. The method of claim 1, further comprising a step of sintering following the step of drying, wherein the green honeycomb structure and plugs are sintered for a sufficient time and at a sufficient temperature to form cordierite.

19. The method of claim 18, wherein the step of sintering is conducted with a peak temperature of above 1300° C.

20. The method of claim 1, wherein the drying step includes orienting the honeycomb structure horizontally.
